(19) United States
(12) Patent Application Publication
(10) Pub. No.: US 2025/0064261 A1
(43) Pub. Date: Feb. 27, 2025

(54) WATER AND OIL TYPE FRYER

(71) Applicant: CLEANCOMPANY INC., Seongnam-si, Gyeonggi-do (KR)

(72) Inventor: Yeong Bok JANG, Gwangju-si (KR)

(73) Assignee: CLEANCOMPANY INC., Seongnam-si, Gyeonggi-do (KR)

(21) Appl. No.: 18/726,736

(22) PCT Filed: Jan. 3, 2023
(86) PCT No.: PCT/KR2023/000060

§ 371 Date: Jul. 3, 2024

(30) Foreign Application Priority Data
Jan. 3, 2022 (KR) 10-2022-0000472

(51) Int. Cl. A47J 37/12

(52) U.S. Cl. CPC A47J 37/129; A47J 37/1261; A47J 37/1266; A47J 2202/00; A47J 2203/00

(57) ABSTRACT

The present invention comprises: a frame part (100) to which a control device (130) is coupled; and a frying body part (200) which comprises: an input part (202) composed of a water storage part (204) that stores water and an oil storage part (206) that is formed above the water storage part (204) and stores oil; a heating member (280) configured in the oil storage part (206) and heating the oil; a temperature sensor (290) sensing the temperatures of the water and the oil and transmitting the sensed temperatures to the control device (130); a water level checking means (220) configured to enable checking of the boundary between the water and the oil and the level of the water; a front body part (210) having the water level checking means (220) configured therein, and forming the input part (202); a side body part (230) coupled to both sides of the front body part (210), and configured such that the oil storage part can be divided into an upper space (A), an intermediate space (B), and a lower space (B), respectively; and a rear body part (240) coupled to a rear surface of the side body part (230), and having the heating member (280) and the temperature sensor (290) mounted thereon.

### TECHNICAL FIELD

The present invention relates to an oil-water separation type fryer, and more specifically, to an oil-water separation type fryer which may prevent stored water from being raised by a predetermined level or greater, may prevent the water from being overheated because a cooling temperature of the water is maintained at 55° C., and may facilitate maintenance of an appropriate temperature of oil.

### BACKGROUND ART

In general, as for fried food, which is cooked by filling oil such as cooking oil in a large container, heating the oil, and then adding food materials into the heated oil to fry the food materials, a specialized fryer capable of controlling a temperature of oil and easily replacing the oil have been used in restaurants and specialized businesses that require more specialized and mass cooking has been used, and recently, an oil-water separation type fryer using characteristics of separating water and oil has been used.

For example, Korean Registered Patent No. 10-2024060 discloses an oil-water separation type gas frying device which stores oil and water in an oil tank such that the oil and the water form layers up and down by using a difference in the specific gravity between the oil and the water, installs a heating pipe capable of heating the oil such that the heating pipe is immersed in the oil of the oil tank, and then discharges a flame into the heating pipe using a gas flame discharge device to heat the oil while the flame moves along the heating pipe, thereby not only rapidly heating the oil to a temperature desired by a user, but also reducing maintenance costs by increasing thermal efficiency.

However, according to the above-described prior art document, even water separated from the oil is heated to a predetermined temperature or higher due to the temperature of the frame, which sharply reduces the specific gravity of water, resulting in a problem of mixing with oil.

Particularly, in the related art, in order to prevent the water from being heated, a structure in which air is naturally introduced through an air cooling pipe is provided, but in the case of using a plurality of oil-water separation type gas frying devices, there is a problem in that, when the heated air is introduced, a temperature of the water is raised to 60° C. or higher, and thus oil is overheated, thereby making it difficult to maintain an appropriate temperature of frying food.

The background art or the related art described herein is only to help understand the technical significance of the present invention, and does not mean a technology widely known in the technical field to which the present invention belongs before the application of the present invention.

### DISCLOSURE

### Technical Problem

To solve the above-described problems, the present invention has been devised by the above-described background art, and an object of the present invention is to provide an oil-water separation type fryer which may prevent stored water from being raised by a predetermined level or greater, may prevent the water from being overheated because a cooling temperature of the water is maintained at 55° C., and may facilitate maintenance of an appropriate temperature of oil.

In addition, another object of the present invention is to provide an oil-water separation type fryer which may periodically clean the fryer as water and oil levels and an amount of settling frying residues may be checked in real time at a front side of the fryer, and simultaneously, which may check a cleaning state of the fryer to allow the fryer to be always clean.

In addition, still another object of the present invention is to provide an oil-water separation type fryer which may shorten a heating time of oil by minimizing an area for a space where the oil is heated, and may maintain an optimum temperature for frying for a long time by checking a temperature of the oil for each layer in real time and controlling the heating temperature of the oil.

However, the objects of the present invention are not limited thereto, and obviously, the objects or effects that may be recognized from the technical solution or embodiment even if not explicitly mentioned is also included therein.

### Technical Solution

To achieve the above objects, according to one embodiment of the present invention, an oil-water separation type fryer includes: a frame part (100) to which a control device (130) is coupled; and a frying body part (200) including: an input part (202) including a water storage part (204) configured to store water and an oil storage part (206) formed above the water storage part (204) to store oil; a heating member (280) provided in the oil storage part (206) to heat the oil; a temperature sensor (290) configured to sense temperatures of the water and the oil to transmit the sensed temperatures to the control device (130); a water level checking unit (220) to check a boundary line between the water and the oil and a level of the water; a front body part (210) including the water level checking unit (220) so as to form the input part (202); side body parts (230) coupled to both sides of the front body part (210), and configured such that the oil storage part is divided into an upper space (A), an intermediate space (B), and a lower space (B); and a rear body part (240) to which rear surfaces of the side body parts (230) are coupled and on which the heating member (280) and the temperature sensor (290) are mounted.

According to one embodiment of the present invention, the frying body part (200) may be configured such that oils stored in the respective spaces (A, B, C) have mutually different temperatures.

According to one embodiment of the present invention, the front body part (210) may include: an oil discharge hole (212) through which the oil is discharged; a projection hole (214) to which the water level checking unit (220) is coupled; lower inclined parts (216) provided at both sides of a lower part of the front body part (210) and configured to form a highest water level point; an upper inclined part (218) configured to have an inclined angle in opposition to the lower inclined part (216); and a water level display part (260) provided coaxially with an upper end of the lower inclined part (216), and configured to check a position of the boundary line between the water and the oil from an outside through the projection hole (214).

According to one embodiment of the present invention, the side body part (230) may include: a lower inclined panel (236) coupled to the lower inclined part (216), and configured to form an upper end of the water storage part (204); a side extension panel (237) extending from an upper end of the lower inclined panel (236) and configured to provide the lower space (C); an upper inclined panel (238) extending from an upper end of the side extension panel (237) such that the upper inclined panel (238) is coupled to the upper inclined part (218), and configured to provide the intermediate space (B).

According to one embodiment of the present invention, the side body part (230) may include: a refrigerant circulation part (232) including a refrigerant supply hole (232a) formed through one side of the side extension panel (237), a refrigerant discharge hole (232b) formed through the other side of the side extension panel (237) facing the refrigerant supply hole (232a), and a cooling pipe (232b) configured to connect the refrigerant supply hole (232a) and the refrigerant discharge hole (232b), and to supply a lower part of the oil storage part (206) such that an external air passes through the lower part of the oil storage part (206); a first refrigerant cover (234) coupled to the side extension panel (237) and having a cooling fan (239) mounted thereon to supply the external air to the refrigerant supply hole (232a); and a second refrigerant cover (235) configured to guide the external air discharged from the refrigerant discharge hole (232b) such that the external air is discharged out of the frying body part (200).

According to one embodiment of the present invention, the upper space (A) may be configured to maintain a temperature of the oil at 170° C. to 180° C., the intermediate space (B), which is a zone where heated oil and cooled oil coexist, may be configured to maintain a temperature at 120° C. to 130° C., and the lower space (C), which is a zone where oil cooled by the external air and a boundary line between the cooled oil and the water are located, may be configured to maintain a temperature of the water at 55° C.

According to one embodiment of the present invention, the rear body part (240) may further include: a blocking bracket configured to block a cable, which is configured to electrically connect the heating member (280) and the temperature sensor (290) to the control device (130), such that the cable is prevented from being exposed to the outside, and a bracket fixing member (245) to which the blocking bracket is fixedly coupled.

According to one embodiment of the present invention, the side body part (230) and the rear body part (240) may further include oil level display parts (250) configured to display a limit point for a low level of the oil and a limit point for a high level of the oil, respectively.

According to one embodiment of the present invention, the water level checking unit (220) may include: an openable fixing flange (222) having a central part formed therethrough; an openable flange (228) rotatably coupled to the openable fixing flange (222); a glass member (224) including a first glass member (224a) which is fixedly inserted into the central part of the openable fixing flange (222) to seal the projection hole (214), and a second glass member (224b) spaced apart from the first glass member (224a) at a predetermined interval, and fixedly coupled to the openable flange (228); and a sealing unit (226) configured to block outflow of the water stored in the water storage part (204) or the oil.

### Advantageous Effects

According to the embodiment of the present invention described above, it is possible to prevent stored water from being raised by a predetermined level or greater, to prevent the water from being overheated because a cooling temperature of the water is maintained at 55° C., and to facilitate maintenance of an appropriate temperature of oil.

In addition, according to the present invention, it is possible to periodically clean the fryer as water and oil levels and an amount of settling frying residues may be checked in real time at a front side of the fryer, and simultaneously, to check a cleaning state of the fryer to allow the fryer to be always clean.

In addition, according to the present invention, it is possible to shorten a heating time of oil by minimizing an area for a space where the oil is heated, and to maintain an optimum temperature for frying for a long time by checking a temperature of oil for each layer in real time and controlling the heating temperature of the oil.

In addition, various advantageous and effects of the present invention are not limited to the above-described contents, and may be more easily understood in the process of describing specific embodiments of the present invention.

### DESCRIPTION OF DRAWINGS

FIG. 1 is a perspective view illustrating an oil-water separation type fryer according to one embodiment of the present invention.

FIGS. 2 and 3 are perspective views illustrating the oil-water separation type according to one embodiment of the present invention.

FIG. 4 is a front view illustrating a frying body part according to one embodiment of the present invention.

FIGS. 5 and 6 are a side view and a plan view illustrating the frying body part, respectively, according to one embodiment of the present invention.

FIG. 7 is a view illustrating a side body part of the frying body part according to one embodiment of the present invention.

FIGS. 8 and 9 are views illustrating a rear body part of the frying body part according to one embodiment of the present invention.

FIG. 10 is a view illustrating a water level checking unit of the frying body part according to one embodiment of the present invention.

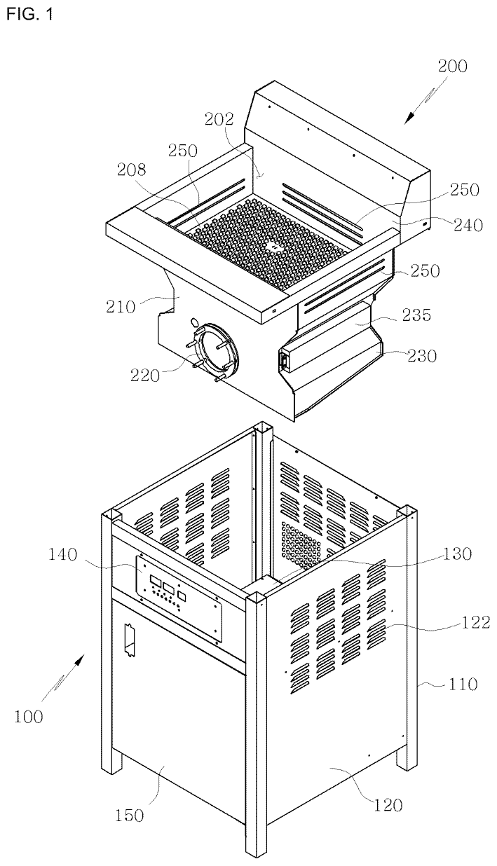

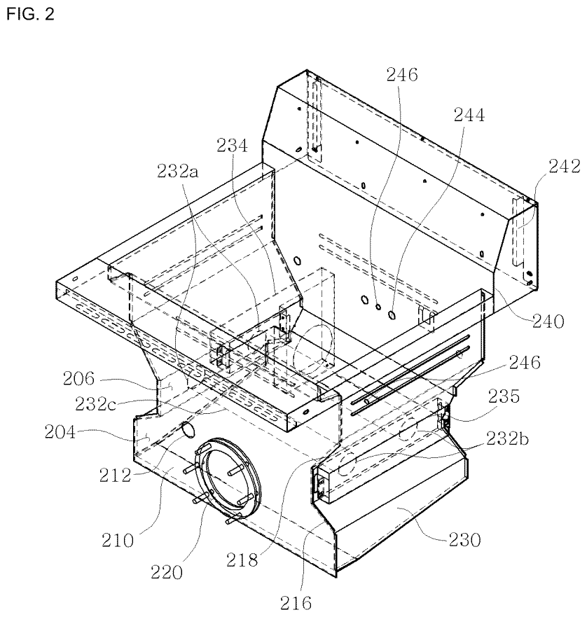

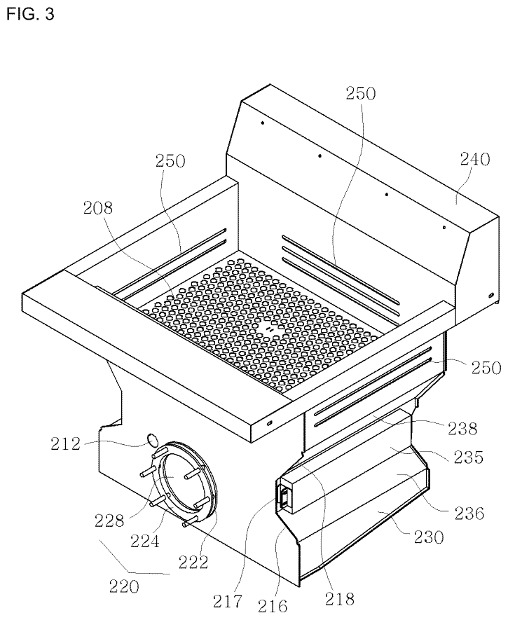

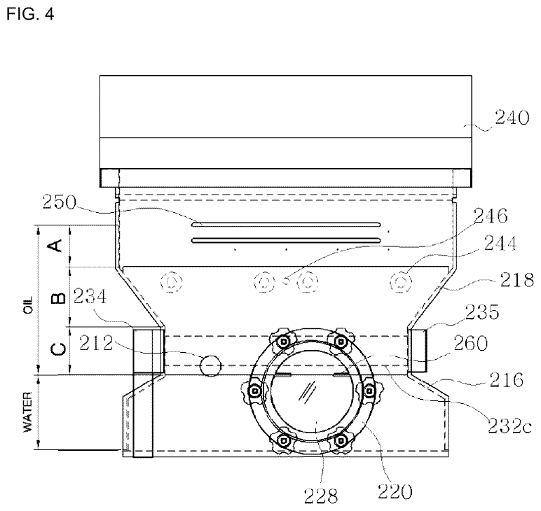

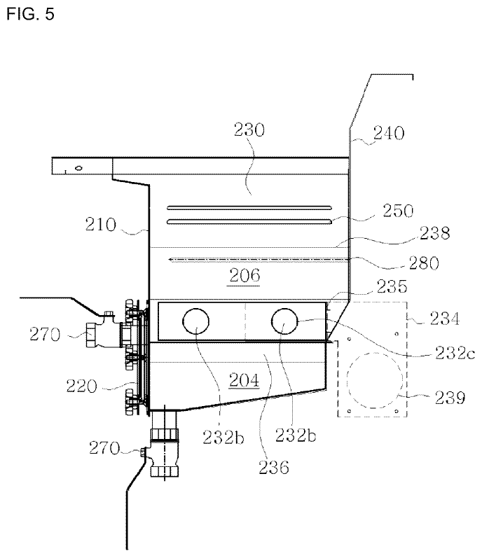

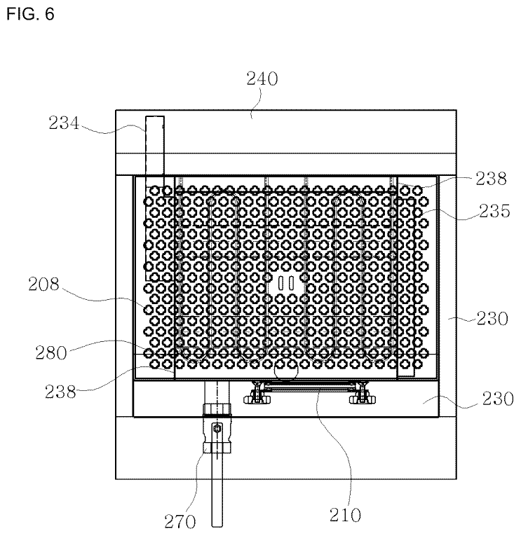

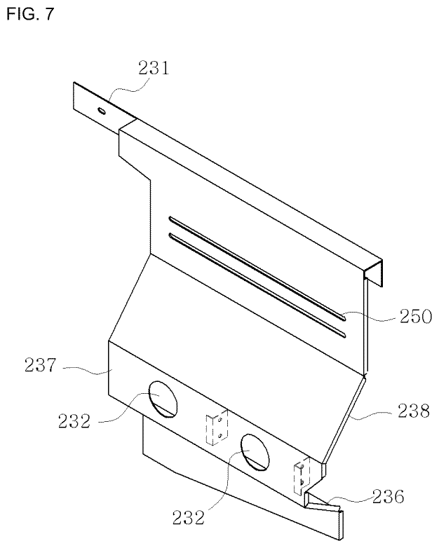

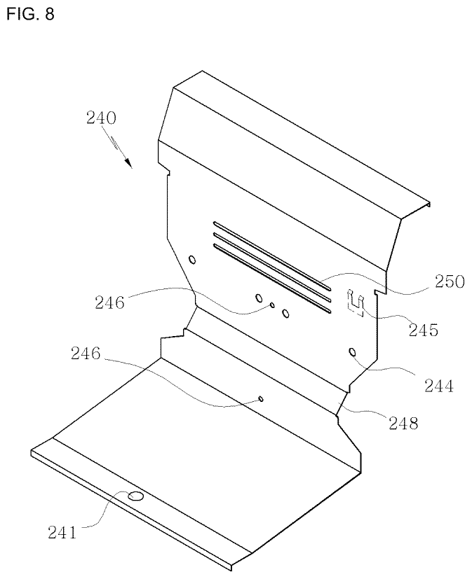

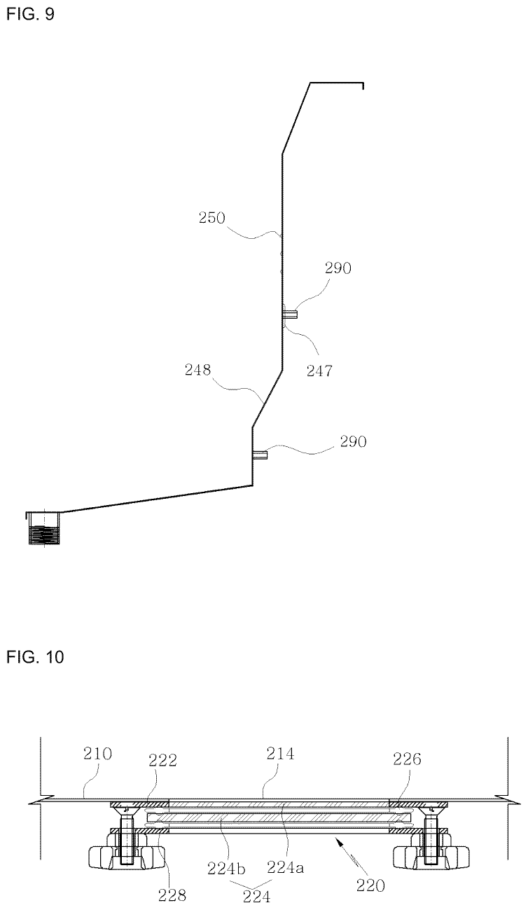

### BEST MODE

According to the present invention, an oil-water separation type fryer includes: a frame part 100 to which a control device 130 is coupled; and a frying body part 200 including: an input part 202 including a water storage part 204 configured to store water and an oil storage part 206 formed above the water storage part 204 to store oil; a heating member 280 provided in the oil storage part 206 to heat the oil; a temperature sensor 290 configured to sense temperatures of the water and the oil to transmit the sensed temperatures to the control device 130; a water level checking unit 220 to check a boundary line between the water and the oil and a level of the water; a front body part 210 including the water level checking unit 220 so as to form the input part 202; side body parts 230 coupled to both sides of the front body part 210, and configured such that the oil storage part is divided into an upper space A, an intermediate space B, and a lower space B; and a rear body part 240 to which rear surfaces of the side body parts 230 are coupled and on which the heating member 280 and the temperature sensor 290 are mounted.

### Mode for Invention

Hereinafter, the preferred embodiments of the present invention will be described with reference to the accompanying drawings. First, it should be noted that in assigning reference numerals to elements in the drawings, the same components will be designated by the same reference numerals although they are shown in different drawings. In addition, when detailed descriptions of related known functions or constitutions are considered to unnecessarily cloud the gist of the present invention in describing the present invention below, the detailed descriptions will not be included.

In addition, the terms “include,” “comprise,” “have,” and the like, which are described below, mean that the corresponding components may be inherent unless otherwise stated, and thus should be interpreted as further including other components rather than excluding other components, and all terms including technical or scientific terms have the same meanings as those generally understood by those skilled in the art to which the present invention pertains, unless otherwise defined. In addition, in describing components of the present invention, the terms like “first,” “second,” “A,” “B,” “(a),” and “(b)” may be used. These terms are merely for differentiating one component from another component, and the essence, sequence, or order of a corresponding component is not limited by the terms. It will be understood that when a component is described as being “connected”, “coupled”, or “linked” to another component, the another component may be directly connected or linked to the other component, but the other component may be “connected”, “coupled”, or “linked” between the respective components.

Hereinafter, embodiments of the present invention will be described in detail with reference to the accompanying drawings.

As illustrated in the drawings, an oil-water separation type fryer of the present invention includes a frame part 100 having a control device 140 mounted thereon and forming an outer surface of the oil-water separation type fryer, and a frying body part 200 coupled to an upper part of the frame part 100 and connected to the control device 140 to constantly maintain a heating temperature of frying oil, thereby providing high-quality fried food.

The frame part 100 includes support frames 110 which are provided at edge portions of the oil-water separation type fryer, respectively, and support the oil-water separation type fryer such that the oil-water separation type fryer may be stably installed on the ground, an outer panel 120 which is connected to the support frame 110 to form both sides and a rear surface of the frame part 100, the control device 140 which is provided on an upper front side of the frame part 100 so as to control driving of the frying body part 200, and an outer door 150 which is provided at a lower part of the control device 140.

In this case, the outer panel 120 forms an outer surface of the frame part 100 with respect to both sides and rear sides of the frame part 100 as both ends of the outer panel 120 are fixedly coupled to the support frames 110, respectively, and has an inflow/outflow hole 122 which guides an external air such that the external air is introduced into a cooling fan 239 of the frying body part 200 to be described later, and guides the introduced external air such that the introduced external air is discharged.

In addition, the frame part 100 further includes a support panel 130 which has the frying body part 200 seated in an internal space formed by the outer panel 120 so as to support a load of the frying body part 200, and is connected to a discharge valve 270 provided on the frying body part 200 to discharge oil and water.

The outer door 150 is provided at the lower part of the control device 140, and has one side rotatably coupled to the support frame 110 to enable an opening/closing operation, and is configured such that a water level checking unit 220 of the frying body part 200, which will be described later, is exposed during the opening/closing operation.

The frying body part 200 is configured such that a front body part 210, a side body part 230, and a rear body part 240 are coupled in perpendicular to one another to form an input part 202 into which the oil and the water are input.

In this case, the input part 202 includes a water storage part 204 which forms a lower part of the input part 202 and into which the water is introduced and stored, and an oil storage part 206 which is provided on the water storage part 204 and supplied with the oil to cook the fried food.

In the frying body part 200, the front body part 210 has an oil discharge hole 212 which is formed in one side of a central part thereof and through which the used oil is discharged.

In this case, the oil discharge hole 212 has a circular shape, is preferably configured such that a branch point of a lower end thereof is located on a boundary line between the water and the oil to prevent the oil from being discharged together with the water when the oil is discharged, and is connected to a discharge valve 270.

Moreover, the front body part 210 includes lower inclined parts 216 which are provided at both sides a lower part thereof so as to form the highest water level point, and an upper inclined part 218 configured to have an inclined angle in opposition to the lower inclined part 216.

In this case, the lower inclined part 216 and the upper inclined part 218 are coupled in perpendicular to a lower inclined panel 236 and an upper inclined panel 238, which will be described later, respectively, and the lower inclined panel 236 and the upper inclined panel 238 form the input part 202 while being coupled in perpendicular to the rear inclined part 248 of the rear body part 240.

In this case, the lower inclined part 216, the lower inclined panel 236, and the rear inclined part 248 are configured to have the same inclined angle, and preferably, they are configured to be directed toward the center of the input part 202 from a lower end to an upper end thereof so that the water storage part 204 of the input part 202 has an area that is gradually narrowed toward the upper end thereof

In addition, the upper inclined part 218 and the upper inclined panel 238 are configured to be directed toward an outer surface of the input part 202 as they are directed from a lower end to an upper end thereof so that the oil storage part 204 of the input part 202 has a shape in which an area that is gradually widened toward an upper end thereof.

Meanwhile, a water level display part 260 is provided coaxially with an upper end of the lower inclined part 216, and is configured to check a position of the boundary line between the water and the oil from the outside through a projection hole 214.

The water level display part 260 may be formed of a circular pipe, but the present invention is not limited thereto, and may be configured to have a shape of a panel coupled to an inner surface of the front body part 210 by welding or the like.

The front body part 210 configured as described above has the projection hole 214 which is formed through the center at a lower part thereof, to which the water level checking unit 220 is coupled, and which is configured to display the water level checking unit 260.

The water level checking unit 220 is coupled to the projection hole 214 and is configured to block outflow of the water and the oil by sealing the projection hole 214, to display the boundary line between the water storage part 204 and the oil storage part 206 of the input part 202, and to check levels of the water stored in the water storage part 204 and the oil.

In this case, the water level checking unit 220 is configured such that the central part thereof is located at a position lower than a central part of the oil discharge hole 212, and preferably, is configured to simultaneously check the levels of the water and the oil while being located coaxially with the boundary line between the water and the oil.

The water level checking unit 220 includes an openable fixing flange 222 which is coupled to an outer surface of the front body part 210 by welding or the like, and has a central part formed therethrough and a penetrated part with the same size as the projection hole 214, a glass member 224 which seals the penetrated central part of the openable fixing flange 222 and is configured to check the water storage part 204 of the frying body part 200 from the outside, and an openable flange 228 to which the glass member 224 is coupled and which is rotatably coupled to the openable fixing flange 222 so as to enable an opening/closing operation of the glass member 224.

In this case, the water level checking unit 220 preferably further includes sealing units 226 which are provided between the openable fixing flange 222 and the glass member 224 and between the openable flange 228 and the glass member 224, respectively, to block outflow of the water stored in the water storage part 204 or the oil.

In addition, the glass member 224 may include a first glass member 224a which is fixedly inserted into the central part of the openable fixing flange 222 to seal the projection hole 214, and a second glass member 224b which is spaced apart from the first glass member 224a at a predetermined interval, and is fixedly coupled to the openable flange 228, but the present invention is not limited thereto.

The side body parts 230 are coupled to both sides of the front body part 210, and include a refrigerant circulation part 232 and first and second refrigerant covers 234 and 235, which are configured to circulate a refrigerant for controlling temperatures of the oil and the water.

The refrigerant circulation unit 232, which absorbs the external air and suppresses an increase in the temperature of the heated oil and water while supplying the external air to a lower part of the oil storage part 206, and discharges the external air that has undergone heat exchange with the oil and the water, includes a refrigerant supply hole 232a which is formed through one side of the side body part 230, a refrigerant discharge hole 232b which is formed through the other side of the side body part 230 facing the refrigerant supply hole 232a, and a cooling pipe 232b which connects the refrigerant supply hole 232a and the refrigerant discharge hole 232b and supports the lower part of the oil storage part 206 such that the external air passes through the lower part of the oil storage unit 206.

In this case, the refrigerant supply hole 232a and the refrigerant discharge hole 232b are formed through a side extension panel 237 provided between the lower inclined panel 236 and the upper inclined panel 238, and a plurality of refrigerant supply holes 232a and a plurality of refrigerant discharge holes 232b are formed while being spaced apart from each other at predetermined intervals.

In addition, the side body part 230 further includes a first refrigerant cover 234 on which the cooling fan 239 is mounted so as to supply the external air to the refrigerant supply hole 232a, and a second refrigerant cover 235 which guides the external air discharged from the refrigerant discharge hole 232b such that the external air is discharged out of the frying body part 200.

In this case, the first and second refrigerant covers 234 and 235 are fixedly coupled to the side extension panel 237.

The side body part 230 has an inclined surface corresponding to the lower and upper inclined parts 216 and 218 described above, and has the lower and upper inclined panels 236 and 238 coupled in perpendicular to the lower and upper inclined parts 216 and 218, respectively.

In this case, the lower inclined panel 236 is configured to form an upper end of the water storage part 204 and to form a limit point for the level of water introduced to the water storage part 204, and serves to suppress expansion of a volume of the water as the water stored in the water storage part 204 is heated due to the temperature of the oil.

Moreover, the upper inclined panel 238 is configured to form a lower surface of the oil storage part 206 and is configured such that a heating member 280 is located on an upper surface of the upper inclined panel 238 and a cooling pipe 232c of the cooling circulation part 232 is located on the lower surface, so that oil located on the heating member 280 is heated and oil at a position adjacent to the water is not heated to a predetermined temperature or higher by the heating member 280, thereby preventing overheating of the water.

That is, the lower end of the upper inclined panel 238 is connected to the lower inclined panel 236 by forming the side extension panel 237 formed of a planar panel, and the refrigerant circulation part 232 and the first and second refrigerant covers 234 and 235 are formed on the side extension panel 237, so that the oil is heated at the upper surface that is gradually widened upward and the oil is suppressed from being heated to a predetermined temperature or higher at the lower surface that is gradually narrowed downward, thereby preventing the water level from changing at the boundary line between the water and the oil due to the overheating of the water and preventing the difficulty of controlling the temperature of the oil, which is optimized for fried food, due to the overheating of the water.

Meanwhile, according to the present invention, heating may be performed by classifying the heating temperature of the oil stored in the internal space of the oil storage part 206 into three steps, the oil storage part 206 may be divided into three spaces, and oils stored in the divided spaces may be configured to form three layers according to the heating temperature.

For example, the divided spaces may include an upper space A formed of a space extending upward from the upper inclined panel 238, and preferably, formed of an upper space of the heating member 280, an intermediate space B formed of a space that is gradually widened by the upper inclined panel 238 and having the heating member 280 disposed therein, and a lower space C formed of a space formed by the side extension panel 237, in which the cooling pipe 232c is disposed and a boundary line between the oil and the water is formed at a lower end of the lower space C.

In this case, the upper space A, which is a space where fried food is cooked, is configured to maintain a temperature of the oil at 170° C. to 180° C., the intermediate space B, which is a zone where heated oil and cooled oil coexist, is configured to maintain a temperature at 120° C. to 130° C., and the lower space C, which is a zone where oil cooled by the external air and a boundary line between the cooled oil and the water are located, is configured to maintain a temperature of the water at 55° C.

Meanwhile, the side body part 230 according to the present invention may further include a coupling flange 231 which extends forward from an upper end side of the side body part 230, and supports the side body part 230 such that the side body part 230 is coupled to the front body part 210.

In this case, although the coupling flange 231 has been described as being formed at the upper end side of the side body part 230, the present invention is not limited thereto, and it is preferable that the coupling flange 231 is formed at a portion where the front body part 210 and the side body part 230 make contact with each other, and a sealing unit such as a gasket, an O-ring, or the like is further provided so as to prevent the leakage of oil and water through the contact portion.

The rear body part 240 is perpendicular to a rear part of the side body part 230, is formed in a shape corresponding to the lower inclined panel 236 on a lower surface thereof to form the intermediate space B and the lower space C, and is formed with a discharge guide hole 241 connected to the discharge valve 270 such that water is drained to a front lower surface of the rear body part 240.

The rear body part 240 is detachably coupled to the outer panel 120 of the frame part 100, and includes a fixing bracket 242 for supporting the frying body part 200 seated in the frame part 100 such that the frying body part 200 may be stably fixed to the frame part 100.

In addition, the rear body part 240 includes a heater mounting hole 244 in which a heating member 280 for heating the oil is installed, and a sensor mounting hole 246 in which a temperature sensor 290 for checking the temperatures of the oil and the water is mounted.

In this case, the rear body part 240 may further include: a blocking bracket configured to block a cable, which is configured to electrically connect the heating member 280 and the temperature sensor 290 to the control device 130, such that the cable is prevented from being exposed to the outside, and a bracket fixing member 245 to which the blocking bracket is fixedly coupled.

In addition, the rear body part 240 preferably further includes a sealing member 247 inserted into the heater mounting hole 244 and the sensor mounting hole 246 such that the sealing properties of the heater mounting hole 244 and the sensor mounting hole 246 may be maximized.

In this case, the sealing member 247 may be coupled to the blocking bracket, but the present invention is not limited thereto.

In addition, the rear body part 240 may further include an oil level display part 250 for displaying an injection limit point of the oil injected up to the upper space A to prevent the oil from being excessively injected.

In this case, the oil level display part 250 may be provided not only on the rear body part 240 but also on the side body part 230.

In addition, a plurality of oil level display parts 250 may be provided while being spaced apart from the bottom to the top at predetermined intervals, and preferably, may be configured to display a limit point for a low level of the oil and a limit point for a high level of the oil, respectively.

Accordingly, a user may easily recognize at which point of the oil level display part 250 the level of the oil is located, thereby checking in real time whether the oil needs to be re-introduced.

The above description illustrates the technical idea of the present invention, and it will be understood by those skilled in the art to which the present invention belongs that various changes and modifications may be made without departing from the scope of the essential characteristics of the present invention. Therefore, the embodiments disclosed herein are not used to limit the technical idea of the present invention, but to explain the present invention, and the scope of the technical idea of the present invention is not limited by those embodiments. The scope of protection of the present invention should be defined by the following claims, and all technical spirits falling within the scope equivalent thereto should be construed as being included in the scope of the present invention.

### DESCRIPTION OF REFERENCE NUMERALS

100: frame part
110: support frame 120: outer panel
122: inflow/outflow hole 130: support panel
140: control device 150: outer door
200: frying body part
202: input part 204: water storage part
206: oil storage part 208: filter member
210: front body part 212: oil discharge hole
214: projection hole 216: lower inclined part
218: upper inclined part 220: water level checking unit
222: openable fixing flange 224: glass member
224a: first glass member 224b: second glass member
226: sealing unit 228: openable flange
230: side body part 232: refrigerant circulation part
232a: refrigerant supply hole 232b: refrigerant discharge hole
232c: cooling pipe 234: first refrigerant cover
235: second refrigerant cover 236: lower inclined panel
238: upper inclined panel 239: cooling fan
240: rear body part 241: discharge guide hole
242: fixing bracket 244: heater mounting hole
246: sensor mounting hole 248: rear inclined part
250: oil level display part 260: water level display part
270: discharge valve 280: heating member
290: temperature sensor

1. An oil-water separation type fryer comprising:
a frame part (100) to which a control device (130) is coupled; and
a frying body part (200) including: an input part (202) including a water storage part (204) configured to store water and an oil storage part (206) formed above the water storage part (204) to store oil; a heating member (280) provided in the oil storage part (206) to heat the oil; a temperature sensor (290) configured to sense temperatures of the water and the oil to transmit the sensed temperatures to the control device (130); a water level checking unit (220) to check a boundary line between the water and the oil and a level of the water; a front body part (210) including the water level checking unit (220) so as to form the input part (202); side body parts (230) coupled to both sides of the front body part (210), and configured such that the oil storage part is divided into an upper space (A), an intermediate space (B), and a lower space (B); and a rear body part (240) to which rear surfaces of the side body parts (230) are coupled and on which the heating member (280) and the temperature sensor (290) are mounted,
wherein the frying body part (200) is configured such that oils stored in the respective spaces (A, B, C) have mutually different temperatures.

2. The oil-water separation type fryer of claim 1, wherein the front body part (210) includes:
an oil discharge hole (212) through which the oil is discharged;
a projection hole (214) to which the water level checking unit (220) is coupled;
lower inclined parts (216) provided at both sides of a lower part of the front body part (210) and configured to form a highest water level point;
an upper inclined part (218) configured to have an inclined angle in opposition to the lower inclined part (216); and
a water level display part (260) provided coaxially with an upper end of the lower inclined part (216), and configured to check a position of the boundary line between the water and the oil from an outside through the projection hole (214).

3. The oil-water separation type fryer of claim 2, wherein the side body part (230) includes:
a lower inclined panel (236) coupled to the lower inclined part (216), and configured to form an upper end of the water storage part (204);
a side extension panel (237) extending from an upper end of the lower inclined panel (236) and configured to provide the lower space (C);
an upper inclined panel (238) extending from an upper end of the side extension panel (237) such that the upper inclined panel (238) is coupled to the upper inclined part (218), and configured to provide the intermediate space (B);
a refrigerant circulation part (232) including a refrigerant supply hole (232a) formed through one side of the side extension panel (237), a refrigerant discharge hole (232b) formed through the other side of the side extension panel (237) facing the refrigerant supply hole (232a), and a cooling pipe (232b) configured to connect the refrigerant supply hole (232a) and the refrigerant discharge hole (232b), and to supply a lower part of the oil storage part (206) such that an external air passes through the lower part of the oil storage part (206);
a first refrigerant cover (234) coupled to the side extension panel (237) and having a cooling fan (239) mounted thereon to supply the external air to the refrigerant supply hole (232a); and
a second refrigerant cover (235) configured to guide the external air discharged from the refrigerant discharge hole (232b) such that the external air is discharged out of the frying body part (200).

4. The oil-water separation type fryer of claim 3, wherein the upper space (A) is configured to maintain a temperature of the oil at 170° C. to 180° C., the intermediate space (B), which is a zone where heated oil and cooled oil coexist, is configured to maintain a temperature at 120° C. to 130° C., and the lower space (C), which is a zone where oil cooled by the external air and a boundary line between the cooled oil and the water are located, is configured to maintain a temperature of the water at 55° C.

5. The oil-water separation type fryer of claim 4, wherein the rear body part (240) further includes:
a blocking bracket configured to block a cable, which is configured to electrically connect the heating member (280) and the temperature sensor (290) to the control device (130), such that the cable is prevented from being exposed to the outside, and a bracket fixing member (245) to which the blocking bracket is fixedly coupled.

6. The oil-water separation type fryer of claim 5, wherein the side body part (230) and the rear body part (240) further include oil level display parts (250) configured to display a limit point for a low level of the oil and a limit point for a high level of the oil, respectively.

7. The oil-water separation type fryer of claim 2, wherein the water level checking unit (220) includes:
an openable fixing flange (222) having a central part formed therethrough;
an openable flange (228) rotatably coupled to the openable fixing flange (222);
a glass member (224) including a first glass member (224a) which is fixedly inserted into the central part of the openable fixing flange (222) to seal the projection hole (214), and a second glass member (224b) spaced apart from the first glass member (224a) at a predetermined interval, and fixedly coupled to the openable flange (228); and
a sealing unit (226) configured to block outflow of the water stored in the water storage part (204) or the oil.
